(19) United States
(12) Patent Application Publication
(10) Pub. No.: US 2015/0251324 A1
(43) Pub. Date: Sep. 10, 2015

(54) FOLDING KNIFE WITH A THUMB PLATE

(71) Applicant: Anton Tkachenko, St. Petersburg (RU)

(72) Inventor: Anton Tkachenko, St. Petersburg (RU)

(73) Assignee: SPORT MANUFACTURING GROUP INC., Forest Hills, NY (US)

(21) Appl. No.: 14/201,205

(22) Filed: Mar. 7, 2014

(51) Int. Cl. B26B 1/02

(52) U.S. Cl. CPC B26B 1/02

(57) ABSTRACT

A folding knife having a rotary blade, a handle and a thumb plate. The rotary blade includes a cutting edge, a non-cutting edge and a tip. The handle is provided with a pivot axis for the blade and is made of two parts connected to each other to form a cavity in which the blade is positioned when the knife is in its closed position. The thumb plate is attached to the non-cutting edge of the blade perpendicularly to the blade. The thumb plate is a flat prism with multiple side facets, two of the facets being elongated and tapering toward the tip of the blade. The flat prism is symmetric or asymmetric with respect to the blade.

### FIELD OF THE INVENTION

The presently disclosed principles and inventions are related to a thumb plate construction for a folding knife.

### BACKGROUND OF THE INVENTION

Retractable or folding knives are very common tools for cutting things. As such knives can be retracted and fully received in a holder when not in use, users can be prevented from being inadvertently wounded by the exposed blade. The popularity of the retractable and folding knives is basically established on the safety protection.

As shown in FIG. 6, in conventional designs of folding or retractable knives, a thumb stud 200 is typically provided to assist the knife user in opening and closing the knife. Another known design of the thumb stud 300 is shown in FIG. 7. Thumb studs used with folding knives are typically cylindrical or spherical in shape, as for example, disclosed in U.S. Pat. No. 8,505,206.

### SUMMARY OF THE INVENTION

In one general aspect, the invention provides a folding knife having a rotary blade, a handle and a thumb plate. The rotary blade includes a cutting edge, a non-cutting edge and a tip. The handle is provided with a pivot axis for the blade and is made of two parts connected to each other to form a cavity in which the blade is positioned when the knife is in its closed position. The thumb plate is attached to the non-cutting edge of the blade perpendicularly to the blade. The thumb plate is a flat prism with multiple side facets, two of the facets being elongated and tapering toward the tip of the blade. The flat prism is symmetric or asymmetric with respect to the blade.

In one specific aspect, the length of each of the elongated facets exceeds the length of each of non-elongated facets by at least 50%.

In another specific aspect, each of the elongated facets is knurled.

The above aspects, advantages and features are of representative embodiments only, It should be understood that they are not to be considered limitations on the invention as defined by the claims. Additional features and advantages of the invention will become apparent in the following description, from the drawings, and from the claims.

### BRIEF DESCRIPTION OF DRAWINGS

The invention is illustrated in the figures of the accompanying drawings which are meant to be exemplary and not limiting, in which like references are intended to refer to like or corresponding parts, and in which:

FIG. 1 is a side perspective view of the folding knife in its open position with the thumb plate in accordance with the first embodiment of the invention;

FIG. 2 is a side perspective view of the knife blade with the attached thumb plate;

FIG. 3 is a side perspective view of the folding knife in its closed position with the thumb plate in accordance with the first embodiment of the invention;

FIG. 4a is a rear perspective view of the thump plate in accordance with the first embodiment of the invention;

FIG. 4b is a front perspective view of the thump plate in accordance with the first embodiment of the invention;

FIG. 4c is a side view of the thump plate in accordance with the first embodiment of the invention;

FIG. 5a is a rear perspective view of the thump plate in accordance with the second embodiment of the invention;

FIG. 5b is a front perspective view of the thump plate in accordance with the second embodiment of the invention;

FIG. 6 is a side perspective view of one conventional design of a folding knife; and

FIG. 7 is a side perspective view of another conventional design of a folding knife.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

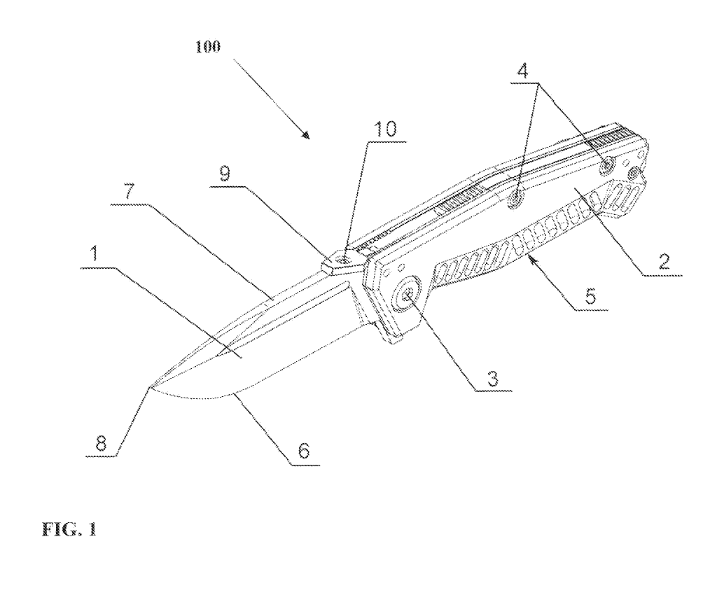

Referring now to the drawings, in which like numerals represent the same or similar elements, and, initially, to FIGS. 1-3, there is shown a folding knife 100, constructed in accordance with one preferred embodiment. Knife 100 preferably includes a handle portion 2 and a knife blade 1. The knife blade 1 is pivotally connected to the handle portion 2 by a pivot mechanism 3 so as to allow the blade to rotate between a closed, or folded, position (shown in FIG. 3) and an open position (shown in FIG. 1). In the preferred embodiment, the pivot mechanism 3 includes a pivot pin and a pivot screw. However, any other known rotary engagement between the blade and the handle portion can be utilized. In its closed position, the blade is at least partially positioned and secured inside a cavity 11 formed within the handle portion. Knife 100 can be provided with a clip 12 secured to the handle portion 2 so that the knife can be clipped onto a belt, a pocket, etc.

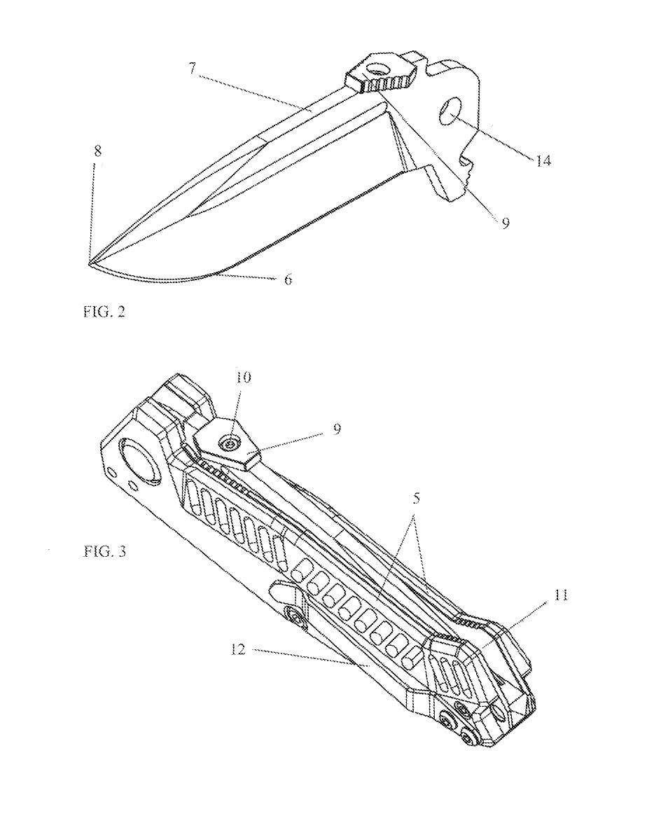

As more particularly shown in FIG. 2, blade 1 has a sharpened cutting edge 6, a tip 8 and a non-sharpened non-cutting edge (or “butt” of the blade) 7. The cutting and non-cutting edges are located opposite each other. The blade also includes an aperture 14 through which the pivot pin of the pivot mechanism 3 extends to rotatably connect the blade to the handle portion.

Handle portion 2 of the preferred embodiment includes two panels 5 secured together by screws 4. Any other known attachment technique can be used to secure the panels together. The inner surfaces of the two panels 5 are laterally spaced from each other to define a storage slot or cavity 11 for receiving the blade in the closed position. In another embodiment, the handle portion can be formed as a single unitary member with an open frame design where one side of the handle portion is open to expose one side of the blade.

Knife 100 can also include a locking mechanism (not shown) to hold the blade in the open position and protect against inadvertent closing of the blade. Various locking mechanisms are known in the art and can be incorporated into the knife 100.

In the first preferred embodiment, to facilitate opening of the blade, a thumb plate 9 sized for a human finger is mounted on the non-cutting edge 7 of the blade. As best shown in FIGS. 1-2, the thumb plate can be secured to the blade by a screw 10 that extends through the thumb plate and is tightened into a threaded opening (not shown) in the non cutting edge of the blade. The thumb plate 9 is preferably positioned along the blade at a location where a manual pressure applied in a direction perpendicular to the surface of the thumb plate displaces the blade relative to the pivot mechanism 3.

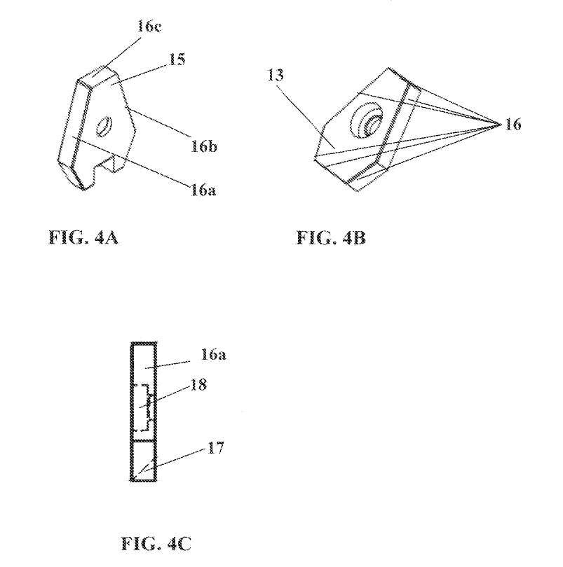

In the illustrated embodiment, as more particularly shown in FIGS. 4A-4C, the thumb plate 9 is a flat prism with a flat top surface 13, flat bottom surface 15 and multiple side facets 16. The top surface is preferably parallel to the bottom surface, and the plate is preferably about 3 mm in thickness. When the thumb plate is secured to the non-cutting edge of the blade, top and bottom surfaces of the thumb plate are preferably positioned perpendicularly to the plane of the blade. In the preferred embodiment, two of the facets (specifically, facets 16a and 16b) are elongated and taper toward one of the shorter facets 16c. When the thumb plate is positioned on the blade, facet 16c is preferably located in a position closest to the tip of the blade. Thus, when the knife is fully assembled, elongated facets 16a and lob of the thumb plate are positioned transversely to the plane of the blade tapering in the direction of the tip of the blade. In accordance with the preferred embodiment, in order to properly accommodate a user's finger and to further ease the process of opening the knife, the length of each of the elongated facets 16a, 16b exceeds the length of each of non-elongated facets by at least 50%. For example, in the illustrated embodiment, the length of the facet 16c is preferably 5.5 mm, and the length of each of facets 16a and 16b is preferably between 12 mm and 13 mm. In the illustrated preferred embodiment, the thumb plate is positioned symmetrically with respect to the blade of the knife. However, an asymmetric positioning is also possible.

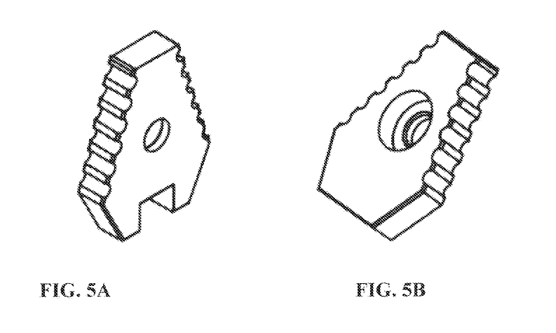

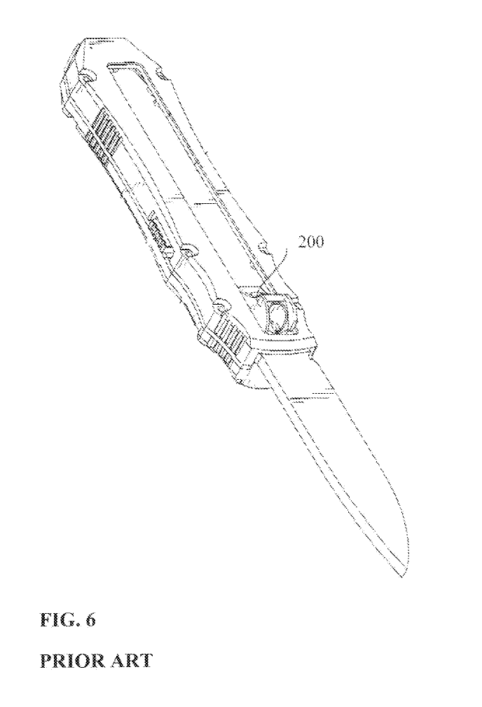

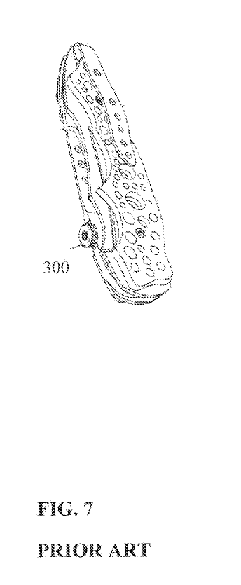

Thumb plate 9 further includes a through-going opening 18, which is shaped to receive the screw 10 therein. Thus, to attach the thumb plate to the knife, screw 10 is inserted into the opening 18 and is secured to the butt of the blade. Further, to properly accommodate the geometry of the non-cutting edge of the blade, the thumb plate may be provided with an aperture 17 shaped complementary to such geometry of the non-cutting edge (e.g., with a slanted wall, as shown in FIG. 4C). Finally, to provide even more grip to the user's finger, the elongated facets (or even all facets) of the thumb plate 9 can be knurled, as shown in FIGS. 5A-5B.

The figures in this disclosure are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above described exemplary embodiments, but should be defined only in accordance with the following claims and their equivalents.

What is claimed is:

1. A folding knife comprising:
a rotary blade having a cutting edge, a non-cutting edge, and a tip;
a handle having a pivot axis for the blade and two parts connected to each other to form a cavity in which the blade is positioned in a closed position; and
a thumb plate attached to the non-cutting edge of the blade perpendicularly to the blade, the thumb plate being a flat prism with multiple side facets, two of the facets being elongated and tapering toward the tip of the blade, the flat prism being symmetric or asymmetric with respect to the blade.

2. The folding knife according to claim 1, further comprising a screw, wherein the thumb plate further comprises a through-going opening and wherein the screw is inserted into the opening and is secured to the butt of the blade.

3. The folding knife according to claim 1, wherein each of the side facets of the flat prism has a length, and wherein the length of each of the elongated facets exceeds the length of each of non-elongated facets by at least 50%.

4. The folding knife according to claim 1, wherein each of the elongated facets is knurled.

5. A thumb plate sized for a human finger and shaped as a flat prism comprising:
a top surface;
a bottom surface parallel to the top surface;
a plurality of side facets, at least two of said side facets being parallel to each other, and at least two more of said side facets being elongated and tapering toward one of said two parallel side facets; and
a through-going opening extending from the top surface to the bottom surface.

6. The thumb plate according to claim 5, wherein each of the side facets of the thumb plate has a length, and wherein the length of each of the elongated side facets exceeds the length of each of non-elongated facets by at least 50%.

7. The thumb plate according to claim 5, wherein each of the elongated side facets is knurled.
